(19) United States
(12) Patent Application Publication
(10) Pub. No.: US 2024/0422642 A1
(43) Pub. Date: Dec. 19, 2024

(54) PROBABILISTIC MOBILITY LOAD BALANCING IN MULTI-BAND MOBILE COMMUNICATION NETWORK

(71) Applicant: SAMSUNG ELECTRONICS CO., LTD., Suwon-si (KR)

(72) Inventors: MHD Saria AL LAHHAM, Montreal (CA); Di WU, Saint-Laurent (CA); Abu Zafar Ekram HOSSAIN, Winnipeg (CA); Xue LIU, Montreal (CA); Gregory Lewis DUDEK, Westmount (CA)

(73) Assignee: SAMSUNG ELECTRONICS CO., LTD., Suwon-si (KR)

(21) Appl. No.: 18/593,262

(22) Filed: Mar. 1, 2024

Related U.S. Application Data
(60) Provisional application No. 63/521,040, filed on Jun. 14, 2023.

(51) Int. Cl. H04W 36/30; H04B 17/318; H04W 36/06; H04W 76/20

(52) U.S. Cl. CPC H04W 36/304; H04B 17/328; H04W 36/06; H04W 76/20

(57) ABSTRACT

A method performed by an electronic device of a wireless communication system, includes: receiving channel qualities and movements reports from a plurality of user equipments; based on the channel qualities and the movements reports, determining whether a load balancing index (LBI) is lower than a predetermined threshold; based on identifying that the LBI is lower than the predetermined threshold, determining an assignment matrix between the plurality of UEs and the plurality of operating bands by calculating minimized maximum band loads and minimized number of inter-frequency handovers (HOs); and transmitting a message to a first UE of the plurality of UEs, wherein the message indicates that the first UE is assigned to a first operating band of the plurality of the operating bands, based on the assignment matrix.

### CROSS-REFERENCE TO RELATED APPLICATION

This application is based on and claims priority under 35 U.S.C. § 119 to U.S. Provisional Patent Application No. 63/521,040, filed on Jun. 14, 2023, in the United States Patent and Trademark Office, the disclosure of which is incorporated by reference herein in its entirety.

### BACKGROUND

### 1. Field

The disclosure relates to a system and a method for enhancing mobility load balancing in wireless networks, for example, multi-band communication networks.

### 2. Description of Related Art

Mobility load balancing (MLB) has been recognized as an important element of managing radio resources, and a core problem in communication networks such as the fifth generation (5G) communication networks. MLB is commonly studied within the context of self-organizing networks (SON), which provides a comprehensive framework for self-optimization and self-healing, thus, MLB becomes a critical aspect of the self-optimization component. MLB in the 3rd generation partnership project (3GPP) standards is defined as moving user equipments (UEs) at an edge of a crowded cell to a less-crowded neighboring cell.

In multi-band communication networks, MLB may additionally move UEs between the available bands via inter-frequency handovers (HOs), based on the channel quality for at least one band. Thus, in the multi-band communication networks, MLB aims to enhance the UEs' throughputs, improve fairness between the UEs, and minimize latencies in data exchanges between base stations and the UEs.

As a number of the UEs and data demand at the UEs increase, coupled with the UEs' demand heterogeneity and mobility, MLB becomes even more important in managing network resources. Thus, there is a need for efficient MLB that can effectively distribute traffics across available resources to ensure an optimal network performance.

In the related art, MLB focuses on an optimal adjustment of the handover (HO) controllable parameters. An example of the HO controllable parameters is ‘cell individual offsets’ (CIOs) that relies on a current load of at least one cell and measurements reported by the UEs, such as the Reference Signal Received Quality (RSRQ). For example, the CIOs may be used as an ‘A3 event’ as defined in the 3GPP standards:

$$A 3 : {R}_{n} - {R}_{s} > {0}_{n , s} + H \qquad Expression ( 1 )$$

In the context of 3GPP standards, specifically regarding 5G NR (New Radio) and LTE (Long-Term Evolution), the A3 event signifies a specific condition encountered by a UE related to neighboring cell signal strength. The A3 event occurs when the RSRQ or a Received Signal Strength Indicator (RSSI) of a neighboring cell becomes stronger than a predefined threshold configured for the event. Upon triggering the A3 event, the UE reports the neighboring cell information to the network (e.g., cell ID, RSRP, RSRQ). The network can then evaluate the reported information and potentially decide to initiate a HO process, switching the UE from its current cell to the newly identified, stronger neighbor.

Nonetheless, CIO-based HO for MLB schemes do not move the UEs between bands, based on their demands or band resources with the inter-frequency HOs, but the CIO-based HO for MLB schemes rely on the fact that the lesser the load of a band, the better the channel quality (e.g., RSRQ). However, once band resources (i.e., Physical Resource Blocks (PRBs)) are fully utilized, the channel quality becomes independent of the current load, and a performance of the CIO-based HO for MLB schemes deteriorates.

### SUMMARY

This disclosure is directed to employ forced handovers (HOs), where a base station (BS) may change an operating band of a user equipment (UE) through a radio resource control (RRC) reconfiguration message. By changing the operating band of the UE, the BS may have a control over moving UEs to more appropriate bands, based on the UE's traffic data and the bands' available resources. To mitigate signaling overheads and minimize interruption times caused by the HOs, a number of inter-frequency HOs and the bands' loads are considered in this disclosure. The following aspects of the disclosure are explained herein.

First, a multi-objective stochastic optimization is formulated to model an assignment of the UE to operating bands. The multi-objective stochastic optimization aims to minimize a maximum load of the operating bands and a number of HOs.

Second, by leveraging transformation methods (e.g., epigraph technique) an estimation, the formulated multi-objective stochastic optimization is converted to an operation (e.g., a Linear Program) to reduce the solution complexity.

Proposed are event-based MLB operations with probabilistic assignment scheme, which uses a solution for the operation (that is converted from the formulated multi-objective stochastic optimization). By using the solution, the assignments of the UE to the operating bands are considered as a probability distribution over the operating bands.

According to one aspect of the disclosure, an electronic device of a wireless communication system, includes: at least one processor; and at least one memory comprising computer program code, wherein the at least one memory and the computer program code are configured, with the at least one processor, to cause the electronic device to at least: receive channel qualities and movements reports from a plurality of user equipments (UEs); based on the channel qualities and the movements reports, determine whether a load balancing index (LBI) is lower than a predetermined threshold, wherein the LBI indicates a level of a distribution of a plurality of loads of the plurality of UEs in a plurality of operating bands for the plurality of UEs; based on identifying that the LBI is lower than the predetermined threshold, determine an assignment matrix between the plurality of UEs and the plurality of operating bands by calculating minimized maximum band loads and minimized number of inter-frequency handovers (HOs), wherein each entry of the assignment matrix comprises a probability of assigning one UE of the plurality of UEs to one operating band of the operating bands; and transmit a message to a first UE of the plurality of UEs, wherein the message indicates that the first UE is assigned to a first operating band of the plurality of the operating bands, based on the assignment matrix.

According to one aspect of the disclosure, a method performed by an electronic device of a wireless communication system, includes: receiving channel qualities and movements reports from a plurality of user equipments (UEs); based on the channel qualities and the movements reports, determining whether a load balancing index (LBI) is lower than a predetermined threshold, wherein the LBI indicates a level of a distribution of a plurality of loads of the plurality of UEs in a plurality of operating bands for the plurality of UEs; based on identifying that the LBI is lower than the predetermined threshold, determining an assignment matrix between the plurality of UEs and the plurality of operating bands by calculating minimized maximum band loads and minimized number of inter-frequency handovers (HOs), wherein each entry of the assignment matrix comprises a probability of assigning one UE of the plurality of UEs to one operating band of the operating bands; and transmitting a message to a first UE of the plurality of UEs, wherein the message indicates that the first UE is assigned to a first operating band of the plurality of the operating bands, based on the assignment matrix.

According to one aspect of the disclosure, an electronic device of a wireless communication system, includes: at least one processor; and at least one memory comprising computer program code, wherein the at least one memory and the computer program code are configured, with the at least one processor, to cause the electronic device to at least: set statistical means of band-assignment probabilities for each band below probability threshold, based on related resources; obtains assignments between a plurality of user equipments (UEs) and a plurality of operating bands, rate measurements of the plurality of UEs, and traffic data statistics of the plurality of UEs; estimate a potential added load from at least one UE of the plurality of UEs to at least one frequency band of the plurality of operating bands; determine an assignment matrix between the plurality of UEs and the plurality of operating bands by calculating minimized maximum band loads and minimized number of inter-frequency handovers (HOs), wherein each entry of the assignment matrix comprises a probability of assigning one UE of the plurality of UEs to one operating band of the operating bands; based on the assignment matrix, obtain a band assignment probability distribution for the at least one UE; and transmit a message to the at least one UE for an inter-frequency HO by the at least one UE.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates example components of an electronic device in accordance with embodiments of the disclosure;

FIG. 2 illustrates example components of an electronic device in accordance with some embodiments of the disclosure;

FIG. 3 shows Table 1 summarizing some symbols or expressions of the disclosure;

FIG. 4 illustrates a first set of operations performed by a load balancing server and a base station, in accordance with some embodiments of the disclosure;

FIG. 5 illustrates a second set of operations performed by a base station, in accordance with some embodiments of the disclosure;

FIG. 6 illustrates a third set of operations performed by the base station, in accordance with some embodiments of the disclosure; and

FIG. 7 illustrates a fourth set of operations performed by the base station, in accordance with some embodiments of the disclosure.

### DETAILED DESCRIPTION

The terms as used in the disclosure are provided to merely describe specific embodiments, not intended to limit the scope of other embodiments. Singular forms include plural referents unless the context clearly dictates otherwise. The terms and words as used herein, including technical or scientific terms, may have the same meanings as generally understood by those skilled in the art. The terms as generally defined in dictionaries may be interpreted as having the same or similar meanings as or to contextual meanings of the relevant art. Unless otherwise defined, the terms should not be interpreted as ideally or excessively formal meanings. Even though a term is defined in the disclosure, the term should not be interpreted as excluding embodiments of the disclosure under circumstances.

According to one or more embodiments, the electronic device may be one of various types of electronic devices. In some embodiments of the disclosure, the electronic devices may include or correspond to a “radio access node,” a “radio network node,” a “radio access network node,” a “core network node,” or a “communication device.”

As used herein, the “radio access node,” the “radio network node,” or the “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (e.g., Next-Generation Node B (gNB)) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

As used herein, the “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

As used herein, the “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

One type of the “communication device” is a wireless communication device, which may be any type of wireless device that has access to (i.e., is served by) a wireless network (e.g., a cellular network). Some examples of a wireless communication device include, but are not limited to: a UE in a 3GPP network, a Machine Type Communication (MTC) device, and an Internet of Things (IOT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

The disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

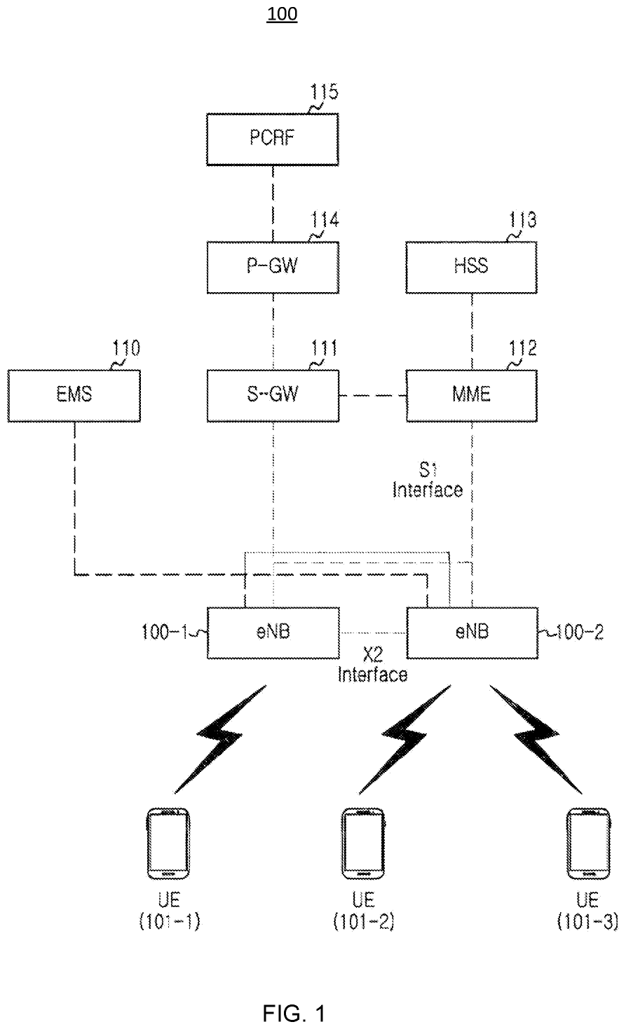

FIG. 1 illustrates a wireless communication system according to some embodiments of the disclosure.

The wireless communication system may include a plurality of Evolved UTRAN Node-B (eNBs) (or “base station”) 100-1 and 100-2, an Element Management System (EMS) 110, a Serving Gateway (S-GW) 111, a Mobility Management Entity (MME) 112, a Home Subscriber Server (HSS) 113, a Packet Data Network (PDN) Gateway (P-GW) 114, and a Policy Charging & Rule Function (PCRF) 115.

The base stations 100-1 and 100-2 may be connected to at least one User Equipment (UE) 101-1 or 101-3 by wireless to process a packet call and perform a transmitting and receiving function of a wireless signal, and a radio resource control function and a modulation and demodulation function of packet traffic data.

The EMS 110 may provide an interface of an operator matching function such that an operator may perform operation and maintenance of the base station and provide software management, configuration management, performance management, and obstacle management functions.

The S-GW 111 may perform a user plane anchor function between a 2G/3G access system and an LTE system and manages and change a packet transmission layer of downlink and uplink data.

The MME 112 may process a control message using a Non-Access Stratum (NAS) signaling protocol with the base stations 100-1 and 100-2 and perform a function of mobility management, tacking area list management, and bearer and session management of a UE.

The HSS 113 may be a database management system that stores and manages parameter and location information of an entire mobile subscriber. The HSS 113 may manage important data such as an access ability, a basic service, and an additional service of a mobile subscriber and perform a routing function of an incoming subscriber.

The P-GW 114 may allocate an Internet Protocol (IP) address to a user UE, manage accounting and a transmission rate according to a service level, and perform an anchor function for mobility between an LTE system and a non-3GPP access system.

The PCRF 115 may generate a policy rule for dynamically applying a Quality of Service (QOS) and an accounting policy distinguished on service flow basis or may generate a policy that can commonly apply to a plurality of service flow.

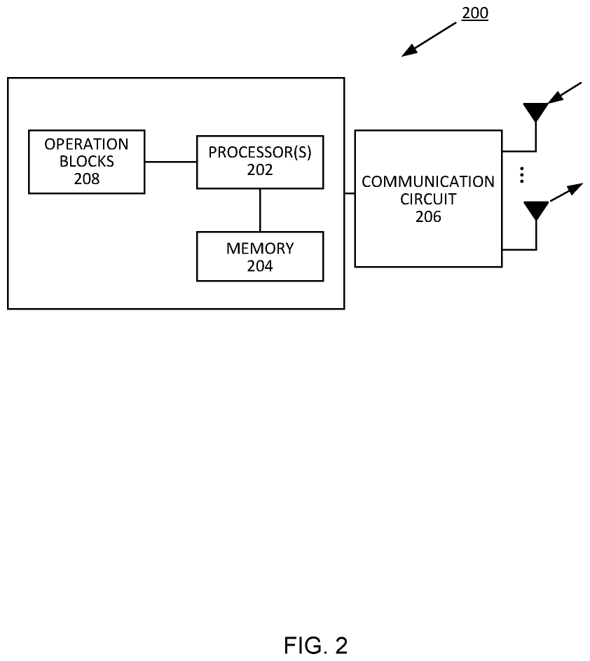

FIG. 2 illustrates example components of an electronic device 200 in accordance with some embodiments of the disclosure. In an embodiment, the electronic device 200 may correspond to the eNB 100-1, 100-2 (collectively referred to as ‘eNB 100’ herein) shown in FIG. 1. In an embodiment, the electronic device 200 may correspond to the UE 101-1, 101-2, or 101-3 (collectively referred to as ‘UE 101’ herein).

In an embodiment, the “processor(s)” 202 (shown in FIG. 2) (hereinafter, may be referred to as ‘the processor 202’) may be implemented in hardware, firmware, or a combination of hardware and software. The processor 202 may be or correspond to one or more processors, such as a central processing unit (CPU), a graphics processing unit (GPU), an application processor (AP), an accelerated processing unit (APU), a neural processing unit (NPU), a tensor processing unit (TCU), a microprocessor, a microcontroller, a digital signal processor (DSP), a field-programmable gate array (FPGA), an application-specific integrated circuit (ASIC), or another type of processing component. The processor 202 may include or one or more processors capable of being programmed to perform at least one function. When the processor 202 includes or corresponds to multiple processors such as a first processor and a second processor, in an embodiment, the first processor performs A, B functions, and the second processor performs C function. In an embodiment, the first processor performs part of A function while the second processor performs the remainder of function A, and B, C functions.

In an embodiment, the memory 204 may include a random access memory (RAM), a read only memory (ROM), and/or another type of dynamic or static storage device (e.g., a flash memory, a magnetic memory, and/or an optical memory) that stores information and/or instructions for use by the processor 202. In an embodiment, the memory 204 may contain information and/or software related to the operation and use of the electronic device 200. For example, the memory 204 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, or another type of non-transitory computer-readable medium, along with a corresponding drive.

In an embodiment, the communication circuit 206 may include a transceiver-like component (e.g., a transceiver and/or a separate receiver and transmitter) that enables the electronic device 200 to communicate with other devices, such as via a wired connection, a wireless connection, or a combination of wired and wireless connections. The communication circuit 206 may permit the electronic device 200 to receive information from another device and/or provide information to another device. For example, the communication circuit 206 may include an Ethernet interface, an optical interface, a coaxial interface, an infrared interface, a radio frequency (RF) interface, a universal serial bus (USB) interface, a Wi-Fi interface, a cellular network interface, or the like. In an embodiment, the communication circuit 206 may be a communication ‘interface’ used to connect the electronic device 200 with the other devices.

In an embodiment, the electronic device 200 may include operation blocks 208, as shown in FIG. 2. The operation blocks 208 may be implement in software, hardware components, or any combination of the software and the hardware components. The operation blocks 208 may provide the functionality of the electronic device 200 e.g., one or more functions of the eNB 100) described herein.

Additionally or alternatively, a set of components (e.g., one or more components) of the electronic device 200 may perform one or more functions described as being performed by another set of components of the electronic device 200.

### System Model

The disclosure relates to a communication (e.g., cellular) network including “N” (macro) eNBs 100, each of which may cover multiple (e.g., three) different cells. At least one cell may be configured to operate over “B” non-overlapping frequency bands, and serve “U” UEs 101 uniformly distributed across the cell.

Within the cell, a set of available bands is denoted by “ [symbol] ” and a set of UEs 101 is denoted by “ [symbol] ”. Throughout this disclosure, an index of the cell is omitted because the disclosure emphasizes on a cell-level multi-band MLB, and at least one cell has its own unique sets of UEs 101 and bands.

As for MLB between different cells, the 3GPP default rule (set for MLB) is employed such as the A2 and A5 events. The downlink (DL) channels for at least one band to at least one user in a cell have time-varying capacities. A UE u's DL channel rate from a band “b” at time “t” is random variable and denoted by r_{u,b}(t).

In an embodiment, r_{u,b}(t) (the UE u's DL channel rate) is chosen from a discrete set of DL channel rates as in a wireless communication system and sampled from a stationary distribution. Different UEs 101 for each band may possibly have heterogeneous rate distributions, depending mainly on the band resources (N_{b}), and the Signal-to-Interference-Noise-Ratio (SINR). Resources of a band are usually represented by a number of physical resource blocks (PRBs) in the band. “U×B” rate matrix in a cell is denoted as R(t), such that the uth row rᵤ(t) (of the “U×B” rate matrix) denotes a rate vector for a UE “u” across all bands, and the bth column r_{b}(t) (of the “U×B” rate matrix) denotes a rate vector in a band b for all the UEs. Afterwards, a full buffer traffic model is considered, and the UEs' demand vector is denoted as d(t), where the UE u's demand at time t is given by:

$${d}_{u} ( t ) = {a}_{u} ( t ) s \qquad Expression ( 2 )$$

In Expression (2), aᵤ(t) is a Poisson random variable with a mean (λᵤ) and aᵤ(t) denotes a number of packets arrived at the UE 101. “s” represents a packet size in bits.

Thus, a load vector for a band “b” is expressed as below:

$${ρ}_{b} t = d ( t ) {⌀r}_{b} ( t ) \qquad Expression ( 3 )$$

In Expression (3), Ø is the Hadamard division operator (i.e., element-wise division). The load vector (Expression (3)) defines how much an UE 101 increases the band's load based on multiple factors such as an incoming traffic data of the UE 101, a channel quality, and a DL rate from the band.

When an UE 101 (in a cell) has a bad channel quality, (which means that an operating band of the UE 101 has a low DL rate,) the UE 101 (in the cell) may need to occupy more PRBs to meet a demand of the UE 101. That is, the UE 101 gives a higher load to the operating band, compared with other UEs 101 (in the cell) having better channel qualities.

### Problem Formulation

The disclosure is directed to balance the loads between the available bands by moving the UEs 101 between different operating bands via forced inter-frequency HOs while minimizing a number of HOs required for balancing the loads. As such, a U×B UE-band assignments matrix is defined in the disclosure. An uth row “xᵤ” (of the U×B UE-band assignments matrix) denotes an assignment vector for a UE “u” between all the operating bands, and the bth column “x_{b}” (of the U×B UE-band assignments matrix) denotes an assignment vector in a band “b” for all the UEs. The assignment entries x_{u,b}=1 when the UE “u” is assigned to a band b, and x_{u,b}=0 otherwise.

Subsequently, a ‘load balancing objective function’ is defined as follows:

$${f}_{1} ( X ) = max ( {x}_{b}^{⊤} E [ {ρ}_{b} ] : b ∈ ℬ ) \qquad Expression ( 4 )$$

Expression (4) represents a maximum load across all the operating bands. E[ρ_{b}] denotes an expected load vector for one band. In an embodiment, a solution for minimizing the maximum load is to keep all the loads the same for all the bands, which may be an aspect of embodiments of the disclosure regarding MLB.

Afterwards, an ‘inter-frequency HOs objective function’ is defined as follows:

$${f}_{2} ( X ) = ‖X - \hat{X} {‖}_{1} \qquad Expression ( 5 )$$

In Expression (5), ∥·∥₁ (for a matrix) denotes the absolute sum of all the entries, and \hat{X} is the UE-band assignments at t−1, which is a time instance prior to the MLB (at time t). There may be a trade-off between the two aspects of the disclosure, namely, (1) minimizing maximum loads of the operating bands (the ‘load balancing objective function’), and (2) minimizing a number of inter-frequency HOs (the ‘inter-frequency HOs objective function’).

The second aspect (“(2) minimizing a number of inter-frequency HOs”) may be achieved in one scenario: X=\hat{X}, which indicates that no UE 101 needs to be relocated to another band, thereby precluding an MLB because there is no HO. In another scenario, all UEs 101 are relocated from their current operating bands to other operating bands, which results in a much worse solution for the second aspect. To address both of the first aspect (the ‘load balancing objective function’) and the second aspect (the ‘inter-frequency HOs objective function) of the disclosure, a scalarized weighted ‘multi-objective optimization problem’ is formulated as follows:

$$\begin{matrix}{min}_{X} & {wf}_{1} ( X ) + ( 1 - w ) {f}_{2} ( X )\end{matrix} \qquad Expression ( 6 a )$$

$$\begin{matrix}such that & ‖ {x}_{u} {‖}_{1} = 1 , & ∀ u ∈ 𝒰\end{matrix} \qquad Expression ( 6 b )$$

$$\begin{matrix}{x}_{u}^{⊤} {r}_{u} \geq {r}_{min} , & ∀ u ∈ 𝒰\end{matrix} \qquad Expression ( 6 c )$$

$$\begin{matrix}{‖x}_{b} {‖}_{1} \leq {n}_{max} , & ∀ b ∈ ℬ\end{matrix} \qquad Expression ( 6 d )$$

$$X ϵ {\{ 0 , 1 \}}^{B \times U} \qquad Expression ( 6 e )$$

Here, w∈[0,1] is an objective weight hyper parameter in the ‘multi-objective optimization problem.

Expression (6b) (∥xᵤ∥₁=1, ∀u∈ [symbol] ) denotes that a UE 101 is assigned to one band only.

Expression (6c) (xᵤ^{T}rᵤ≥rₘᵢₙ, ∀u∈ [symbol] ) denotes that a minimum (DL channel) rate of “rₘᵢₙ” is granted to the UE 101.

Expression (6d) (∥x_{b}∥₁≤nₘₐₓ, ∀b∈ [symbol] ) avoids over-congesting bands that have better channel qualities and offer higher data rates by setting a cap “nₘₐₓ” on a number of the UEs 101 on this band. Here, “nₘₐₓ” is proportional to the bands' resources.

Expression (6e) (X∈{0,1}^{B×U}) denotes that the decision variable is a binary matrix.

$$( \begin{matrix}{min}_{X} & {wf}_{1} ( X ) + ( 1 - w ) {f}_{2} ( X ) ) ,\end{matrix} \qquad Expression ( 6 a )$$

which is the scalarized weighted ‘multi-objective optimization problem’) is an NP-hard integer nonlinear program and a stochastic optimization problem by having the UEs' data rate and the incoming traffic data as random vectors in f₁(X) (max(x_{b}^{T}E[ρ_{b}]:b∈ [symbol] ). To tackle these challenges, embodiments of the disclosure propose relaxing the integer decision variables and estimating the random variables, as described below.

### Methodology and Proposed Solution

A scheme for solving the scalarized weighted ‘multi-objective optimization problem’ (Expression (6a) with the conditions of Expressions (6b) to (6e)) is described herein. The scheme aims to redistribute the UEs across the bands, and thus, the maximum bands' load is minimized while reducing the number of inter-frequency HOs needed to optimize the loading balance.

### A. Problem Transformation

A possible infeasibility may result from Expression (6c) (xᵤ^{T}rᵤ≥rₘᵢₙ, ∀u∈ [symbol] ), where a UE 101 may have data rates that are lower than rₘᵢₙ due to bad channel conditions, and such UE 101 does not satisfy the MLB rule that is set to move to a neighboring cell. Thus, a possible solution is to associate the UE 101 with a band “b” that has the best channel quality, which is denoted as follows:

$$b = arg {max}_{b} {γ}_{u} \qquad Expression ( 7 )$$

In Expression (7), ‘arg max’ (or ‘argmax’) is an operation that finds an argument that gives the maximum value from a target function. In Expression (7), γᵤ={γ₁, . . . , γ_{B}} is a set of RSRQ values of a UE “u” in each band. An UE 101, which is relocated based on the aforementioned solution (Expression (6a)) adds a load to the associated band. As a result, an incurred load to the band “b” prior to the optimization is denoted as “\hat{ρ} _{b}”, then the UE 101 is removed from the set of considered UEs “ [symbol] ” in the optimization.

Afterwards, to deal with random vectors in the ‘load balancing and HOs minimization objective function,’ which corresponds to

$$( {min}_{X} {wf}_{1} ( X ) + ( 1 - w ) {f}_{2} ( X ) ) , \qquad Expression ( 6 a )$$

the expected value of the random variables from observed samples over a time period “Δt” may be considered as an estimation instead of instantaneous samples. Prior to solving the optimization, the load vector in ‘f₁(X)’ is replaced by ρ_{b}=E[ρ_{b}t], where the expectation is considered over time. Nevertheless, the choice of Δt may be important, because having a relatively small or large values can lead to sub-optimal solutions.

Subsequently, to address the integrality of the problem, the integer variables of the problem are converted to continuous ones in the range of [0,1]. The disclosure proposes a probabilistic rounding approach, which uses Expression (6b) (∥xᵤ∥₁=1, ∀u∈ [symbol] ) and regards the UE assignment vector “xᵤ” as a probability distribution over the bands. Accordingly, embodiments of the disclosure have better solutions and mitigate the deterministic rounding errors that might occur in the solution. Embodiments of the disclosure take into account the probabilistic nature of the problem. Accordingly, after solving the optimization, for an UE 101, there exists a probability distribution “Pᵤ” that takes on the values of {1, 2, . . . ,B}, and has probabilities of “xᵤ,” and then, to select the assigned band “b”, the band to be assigned is sampled from that distribution, i.e., b˜Pᵤ.

To transform the problem into an equivalent operation (such as Linear Program (LP)), an epigraph (e.g., a set of points that lie on or above a graph of a function) technique is leveraged to linearize the objective function (Expression (6a), which is

$${min}_{X} {wf}_{1} ( X ) + ( 1 - w ) {f}_{2} ( X ) )$$

by first introducing a non-negative slack variable “t” (note that, in an optimization problem, a slack variable is a variable added to an inequality constraint to transform the inequality constraint to an equality), such that:

$${x}_{b}^{T} {ρ}_{b} \leq t , ∀ b ∈ ℬ \qquad Expression ( 8 )$$

In Expression (8), “t” replaces “f₁(X)”. Additional slack variables “y” and “y_{b}” are introduced where:

$$y = {\sum }_{b ∈ ℬ} {‖ {y}_{b} ‖}_{1} \qquad Expression ( 9 a )$$

$${x}_{b} - {\hat{x}}_{b} ⪯ {y}_{b} \qquad Expression ( 9 b )$$

$$- ( {x}_{b} - {\hat{x}}_{b} ) ⪯ {y}_{b} \qquad Expression ( 9 c )$$

In Expressions (9b) and (9c), “≤” is the element-wise “≤” comparison. Consequently, an equivalent transformed operation is formulated as follows:

$${min}_{X , {y}_{b} , t , y} wt + ( 1 - w ) y \qquad Expression ( 10 a )$$

$$such that {‖ {x}_{u} ‖}_{1} = 1 \qquad Expression ( 10 b )$$

$${x}_{u}^{⊤} {r}_{u} \geq {r}_{min} , ∀ u ∈ 𝒰 \qquad Expression ( 10 c )$$

$${‖ {x}_{b} ‖}_{1} \leq {n}_{max} , ∀ b ∈ ℬ \qquad Expression ( 10 d )$$

$${x}_{b}^{⊤} {ρ}_{b} + {\hat{ρ}}_{b} \leq t , ∀ b ∈ ℬ \qquad Expression ( 10 e )$$

$${x}_{b} - {\hat{x}}_{b} ⪯ {y}_{b} , ∀ b ∈ ℬ \qquad Expression ( 10 f )$$

$$- ( {x}_{b} - {\hat{x}}_{b} ) ⪯ {y}_{b} , ∀ b ∈ ℬ \qquad Expression ( 10 g )$$

$${\sum }_{b ∈ ℬ} {‖ {y}_{b} ‖}_{1} = y \qquad Expression ( 10 h )$$

$$y \geq 0 , t \geq 0 , {y}_{b} ⪰ 0 , X ∈ {[ 0 , 1 ]}^{B \times U} \qquad Expression ( 10 i )$$

Expression (10a) is an equivalent transformed operation of Expression (6a). That is, in Expression (10a), f₁(X) of Expression (6a) is replaced with the non-negative slack variable t and f₂(X) is replaced with the non-negative slack variable y. Expression (10b) is identical to Expression (6b). Expression (10c) is identical to Expression (6c). Expression (10c) and Expression (10d) are identical to Expression (6c) and Expression (6d), respectively.

As an example of the operation, the equivalent transformed operation is a well-established and widely-used optimization technique, for which many efficient and low-complexity operations have been developed, in addition to a variety of open sourced solvers. In an embodiment, the two aspects t and y are normalized in the range of [0,1] by dividing over the maximum values of the aspects f₁(X) and f₂(X), respectively.

### B. Operations

Two aspects of the disclosures are: first, the optimal frequency at which the optimization needs be performed and, second, whether the optimization needs to be performed periodically in the first place. These two aspects are contingent upon numerous factors including the mobility and data traffic patterns of the UEs 101. An embodiment of the disclosure proposes to perform the optimization at a period of Δt minute, such that an event is satisfied based on data distribution of the UEs 101 across the operating bands. Thus, to indicate how much the loads between the operating bands are evenly distributed, a ‘load balancing index (LBI),’ which indicates how much the loads between the operating bands are evenly distributed, is denoted as follows:

$$LBI = \frac{{( {\sum }_{b} {\overline{ρ}}_{b} )}^{2}}{B {\sum }_{b} {\overline{ρ}}_{b}^{2}} \qquad Expression ( 11 )$$

In Expression (11), ρ̅ _{b}=∥ρ_{b}(t)∥₁ represents a load in the band b. The LBI may correspond to Jain's Fairness Index (JFI), but between loads of two operating bands. Usually, the JFI is used to quantify how the resources are uniformly distributed in resource allocation problems. In a similar manner, the JFI may also quantify how the loads are balanced since the disclosure aims to keep the bands' loads uniformly distributed.

The LBI (Expression (11), which is

$$\frac{{( {\sum }_{b} {\overline{ρ}}_{b} )}^{2}}{B {\sum }_{b} {\overline{ρ}}_{b}^{2}} )$$

may vary based on (a) channel qualities, reported from the UEs 101, of the operating bands assigned to the UEs 101, and (b) movements reports of the UEs 101, which indicate when the UEs 101 enter and leave the cell since the UEs 101 either add or remove loads from the bands.

Consequently, the event is defined as an occurrence at which the LBI drops below a threshold, i.e., LBI≤Lₜₕ. This defined event leads to less inter-frequency HOs since no UEs 101 is relocated if the event is not triggered. In other words, base station (e.g., the eNB) 100 may instruct the inter-frequency HO to the UE 101 only when the above condition is met: LBI≤Lₜₕ. The base station (e.g., the eNB) 100 may execute the optimization for a corresponding cell by performing a load balancing between the operating bands in that cell, for example, based on the above described Expressions, such as

$$( {min}_{X , {y}_{b} , t , y} wt + ( 1 - w ) y ) . \qquad Expression ( 10 a )$$

The above described embodiments of the disclosure may be called as ‘a probabilistic MLB (PMLB).’ In other words, for the PMLB of at least one band in a cell, the base station 100 may receive measurement reports, the DL rate, and incoming traffic data sizes for an UE 101. The base station 100 may calculate values of the loads that the UEs 101 are going to add to the bands, and store the values of the loads; at each Δt, the base station 100 may check the LBI event, if the loads are unbalanced. the eNB 100 may perform the feasibility checks and solve the operation (LP) shown in

$$( {min}_{X , {y}_{b} , t , y} wt + ( 1 - w ) y ) . \qquad Expression ( 10 a )$$

eNB 100 may assign one of the UEs 101 to a band, based on probability distributions obtained by solving the operation (LP).

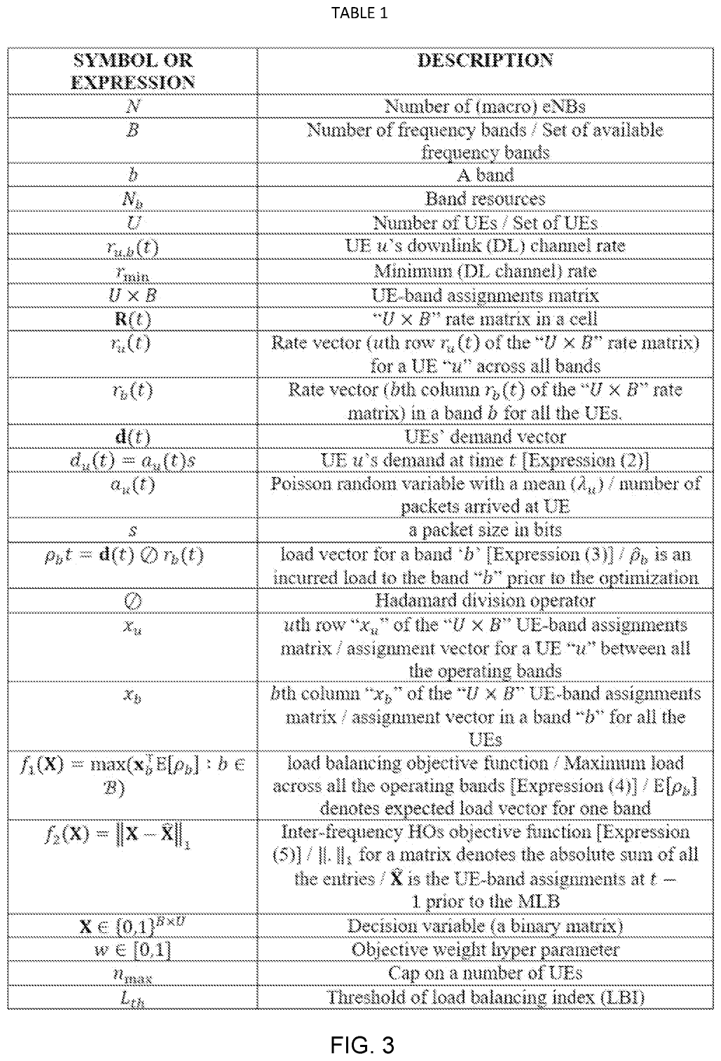

FIG. 3 shows Table 1 summarizing some symbols or expressions of the disclosure.

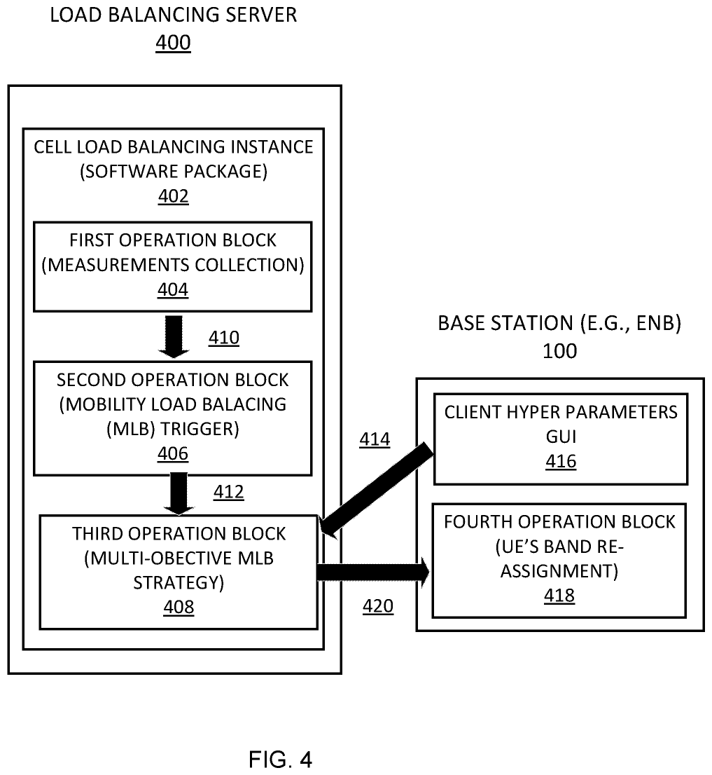

FIG. 4 illustrates a first set of operations performed by a load balancing server 400 and the base station 100, in accordance with some embodiments of the disclosure. The load balancing server 400 includes a cell load balancing instance 402, which may correspond to a software package or a ‘container’ (e.g., a ‘docker container’ that can encapsulate all the optimization software and its dependencies). The cell load balancing instance 402 may include a first operation block 404, a second operation block 406, and a third operation block 408. In an embodiment, the load balancing server 400 may be included in the base station (eNB) 100. For example, the load balancing server 400 may be a part of the base station 100. In an embodiment, the load balancing server 400 may correspond to the base station 100. In an embodiment, the load balancing server 400 may be a station located outside the base station (eNB) 100.

The first operation block 404 may perform a measurements collection operation and transmit a result of the operation to the second operation block 406 (operation 410). In an embodiment, the load balancing server 400 (i.e., the first operation block 404) may receive measurements of channel qualities (such as the RSRQ), DL rates, and incoming traffic data, which are reported by the UE 101.

The second operation block 406 may trigger an MLB and, based on the triggered MLB and let the third operation block 408 knows that the MLB is triggered (operation 412). In an embodiment, the load balancing server 400 (i.e., the second operation block 406) may check whether the LBI event (LBI≤Lₜₕ where

$$LBI = \frac{{( {\sum }_{b} {\overline{ρ}}_{b} )}^{2}}{B {\sum }_{b} {\overline{ρ}}_{b}^{2}} )$$

is triggered.

The third operation block 408 performs a multi-objective MLB strategy. In an embodiment, the load balancing server 400 (i.e., the third operation block 408) may perform the feasibility checks and solve the operation (LP) of

$$( {min}_{X , {y}_{b} , t , y} wt + ( 1 - w ) y ) . \qquad Expression ( 10 a )$$

To perform the multi-objective MLB strategy, the third operation block 408 receives the client hyper parameters from the base station 100 (operation 414). In an embodiment, the client hyper parameters are w∈[0,1].

The base station 100 includes a graphic user interface (GUI) 416 to receive the client hyper parameters from an operator (or a client). In the base station 100, after receiving a result of the multi-objective MLB strategy from load balancing server 400 (operation 420), based on the received results, the base station 100 (i.e., the fourth operation block 418) performs UE's band reassignment. In an embodiment, the base station 100 may assign one of the UEs 101 to a band, based on probability distributions obtained by solving the operation (LP) of

$$( {min}_{X , {y}_{b} , t , y} wt + ( 1 - w ) y ) . \qquad Expression ( 10 a )$$

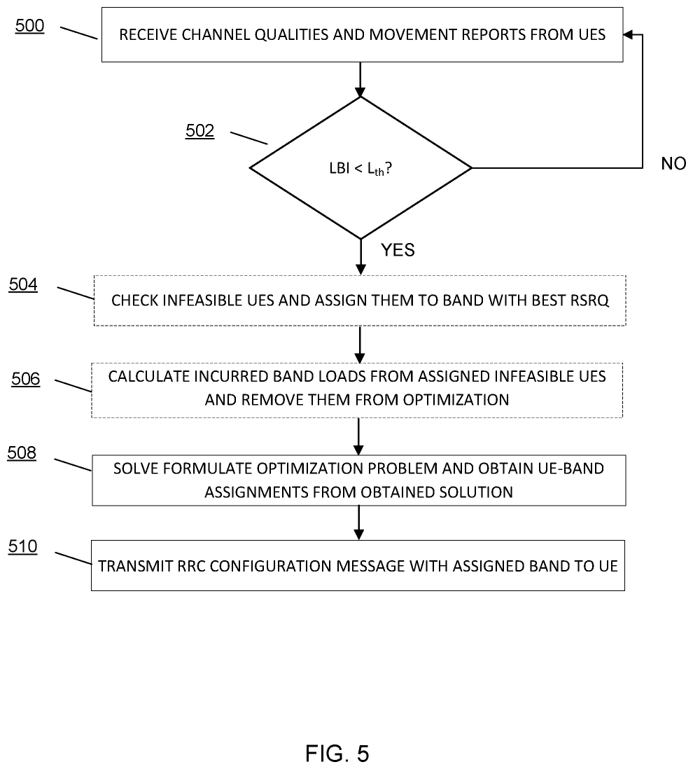

FIG. 5 illustrates a second set of operations performed by the base station 100, in accordance with some embodiments of the disclosure.

In operation 500, the base station 100 receives channel qualities and movement reports from the UEs 101.

In operation 502, the base station 100 determines whether LBI is lower than a predetermined threshold (Lₜₕ), which triggers a load balancing. If ‘Yes,’ operation 504 is performed. If ‘no,’ operation 500 is repeated. In an embodiment, based on the channel qualities and the movements reports, the base station 100 determine whether LBI is lower than a predetermined threshold. LBI may indicate a level of a distribution of a plurality of loads of the plurality of the UEs 101 in a plurality of operating bands for the plurality of the UEs 101;

In operation 504, the base station 100 checks infeasible UEs (e.g., UEs that do not or cannot perform inter-frequency HOs) and assign frequency bands with best channel qualities (e.g., RSRQs) to the infeasible UEs. In an embodiment, the base station 100 assign an second UE (corresponding to the infeasible UE) in the plurality of UEs 101 to a second operating band, wherein the second UE is excluded from performing the inter-frequency HOs, and wherein the second operating band has the highest value of channel quality among the plurality of operating bands. In an embodiment, a data rate of the second UE is lower that a predetermined minimum data rate of the wireless communication system.

In operation 506, the base station 100 calculates band loads incurred from the assigned infeasible UEs that are removed from an optimization procedure.

In operation 508, with respect to the UEs (excluding the infeasible UEs already assigned to bands having the bet channel qualities), the base station 100 solves the formulated optimization problem, and thus, obtain UE-band assignments from a solution of the formulated optimization problem. In an embodiment, the formulated optimization problem is

$$( {min}_{X , {y}_{b} , t , y} wt + ( 1 - w ) y ) , \qquad Expression ( 10 a )$$

which is described above. In an embodiment, the solution of the formulated optimization problem is a matrix having a plurality of bands in rows (or columns) and a plurality of UEs in columns (or rows). Each entry of the matrix has a probability of assigning a particular UE to a particular band, which would achieve the optimal results, e.g., minimized maximum bands loads and minimized number of inter-frequency HOs. In an embodiment, the base station 100 determines an assignment matrix between the plurality of UEs 101 and the plurality of operating bands by calculating minimized maximum band loads and minimized number of inter-frequency HOs, wherein each entry of the assignment matrix comprises a probability of assigning one UE of the plurality of UEs 101 to one operating band of the operating bands. In an embodiment, the calculation of minimized maximum band loads and minimized number of inter-frequency includes at least one non-negative slack variable.

In operation 510, the base station 100 transmits RRC configuration messages (with the assigned bands) to the UEs. If needed, the UEs may initiate a HO process to the assigned bands. In an embodiment, the base station 100 transmits a message to a first UE of the plurality of UEs 101, wherein the message indicates that the first UE is assigned to a first operating band of the plurality of the operating bands, based on the assignment matrix. In an embodiment, the message corresponds to the RRC configuration message.

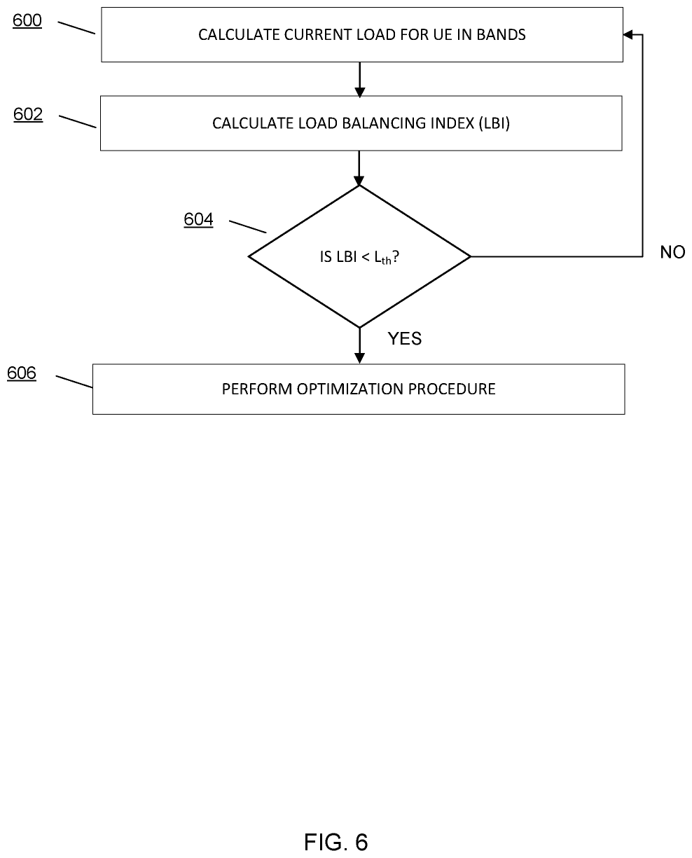

FIG. 6 illustrates a third set of operations performed by the base station 100, in accordance with some embodiments of the disclosure.

In operation 600, the base station 100 calculates a current load for at least one UE (e.g., a plurality of UEs) in at least one band (e.g., a plurality of bands), for example, at a predetermined time instance.

In operation 602, the base station 100 calculates the load balancing index (LBI).

In operation 604, the base station 100 determines whether the calculated LBI is

lower than Lₜₕ. If ‘YES,’ the base station 100 performs operation 606. If ‘NO,’ the base station 100 repeats operation 600.

In operation 606, the base station 100 performs the optimization procedure. In an embodiment, the base station 100 solves the formulated optimization problem, and thus, obtain UE-band assignments from a solution of the formulated optimization problem. In an embodiment, the formulated optimization problem is

$$( {min}_{X , {y}_{b} , t , y} wt + ( 1 - w ) y ) , \qquad Expression ( 10 a )$$

which is described above. In an embodiment, the solution of the formulated optimization problem is a matrix having a plurality of bands in rows (or columns) and a plurality of UEs in columns (or rows). Each entry of the matrix has a probability of assigning a particular UE to a particular band, which would achieve the optimal results, e.g., minimized maximum bands loads and minimized number of inter-frequency HOs.

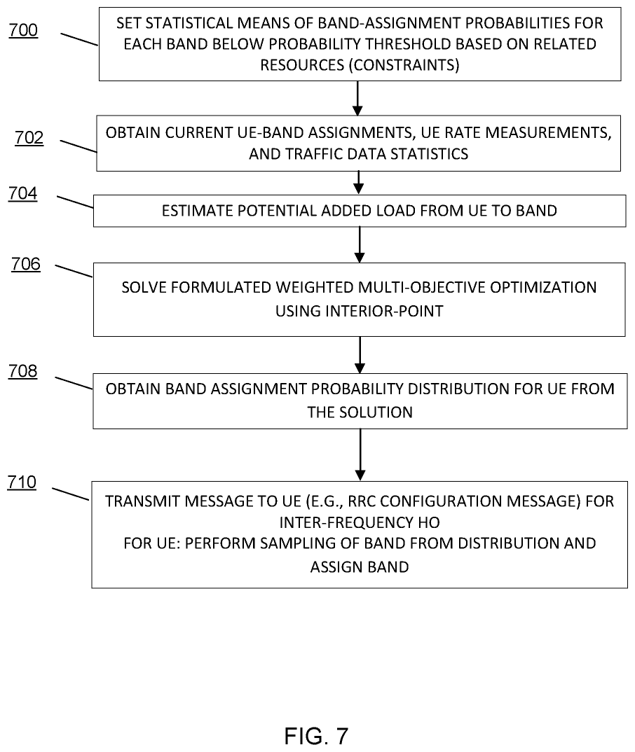

FIG. 7 illustrates a fourth set of operations performed by the base station 100, in accordance with some embodiments of the disclosure.

In operation 700, the base station 100 sets statistical means of band-assignment probabilities for each band below probability threshold, based on related resources (constraints, e.g., data rates, channel qualities).

In operation 702, the base station 100 obtains current UE-band assignments, UE rate measurements, and traffic data statistics. In an embodiment, the base station 100 obtains assignments between a plurality of UEs 101 and a plurality of operating bands, rate measurements of the plurality of UEs 101, and traffic data statistics of the plurality of UEs 101.

In operation 704, the base station 100 estimates a potential added load from at least one UE to at least one band.

In operation 706, the base station 100 solves formulated weighted multi-objective optimization using interior-point. In an embodiment, the base station 100 determines an assignment matrix between the plurality of UEs and the plurality of operating bands by calculating minimized maximum band loads and minimized number of inter-frequency handovers (HOs), wherein each entry of the assignment matrix comprises a probability of assigning one UE of the plurality of UEs to one operating band of the operating bands.

In operation 708, the base station 100 obtains band assignment probability distribution for at least one UE from the solution (based on a result of operation 706). In an embodiment, the base station 100 obtains band assignment probability distribution for at least one UE based on the assignment

In operation 710, for at least one UE 101, the base station 100 performs a sampling of a band from a distribution and assign the band to the UE. In an embodiment, the base station 100 transmits a message to the at least one UE 101 for an inter-frequency HO by the at least one UE 101. In an embodiment, the message corresponds to an RRC configuration message.

One or more embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

According to one or more embodiments, in a non-volatile storage medium storing instructions, the instructions may be configured to, when executed by at least one processor, cause the at least one processor to perform at least one operation. The at least one operation may include displaying an application screen of a running application on a display, identifying a data input field included in the application screen, identifying a data type corresponding to the data input field, displaying at least one external electronic device, around the electronic device, capable of providing data corresponding to the identified data type, receiving data corresponding to the identified data type from an external electronic device selected from among the at least one external electronic device through a communication circuit, and entering the received data into the data input field.

The embodiments of the disclosure described in the present specification and the drawings are only presented as specific examples to easily explain the technical content according to the embodiments of the disclosure and help understanding of the embodiments of the disclosure, not intended to limit the scope of the embodiments of the disclosure. Therefore, the scope of one or more embodiments of the disclosure should be construed as encompassing all changes or modifications derived from the technical spirit of one or more embodiments of the disclosure in addition to the embodiments disclosed herein.

What is claimed is:

1. An electronic device of a wireless communication system, the electronic device comprising:
at least one processor; and
at least one memory comprising computer program code, wherein the at least one memory and the computer program code are configured, with the at least one processor, to cause the electronic device to at least:
receive channel qualities and movements reports from a plurality of user equipments (UEs);
based on the channel qualities and the movements reports, determine whether a load balancing index (LBI) is lower than a predetermined threshold, wherein the LBI indicates a level of a distribution of a plurality of loads of the plurality of UEs in a plurality of operating bands for the plurality of UEs;
based on identifying that the LBI is lower than the predetermined threshold, determine an assignment matrix between the plurality of UEs and the plurality of operating bands by calculating minimized maximum band loads and minimized number of inter-frequency handovers (HOs), wherein each entry of the assignment matrix comprises a probability of assigning one UE of the plurality of UEs to one operating band of the operating bands; and
transmit a message to a first UE of the plurality of UEs, wherein the message indicates that the first UE is assigned to a first operating band of the plurality of the operating bands, based on the assignment matrix.

2. The electronic device of claim 1, wherein the at least one memory and the computer program code are further configured, with the at least one processor, to cause the electronic device to assign an second UE in the plurality of UEs to a second operating band of the plurality of operating bands,
wherein the second UE is excluded from performing the inter-frequency HOs, and
wherein the second operating band has the highest value of channel quality among the plurality of operating bands.

3. The electronic device of claim 2, wherein the channel qualities correspond to reference signal received quality (RSRQ).

4. The electronic device of claim 2, the second UE is excluded from the calculating minimized maximum band loads and minimized number of inter-frequency HOs.

5. The electronic device of claim 2, a data rate of the second UE is lower that a predetermined minimum data rate of the wireless communication system.

6. The electronic device of claim 1, wherein the message corresponds to a radio resource control (RRC) configuration message.

7. The electronic device of claim 1, wherein the calculating minimized maximum band loads and minimized number of inter-frequency comprises at least one non-negative slack variable.

8. The electronic device of claim 1, wherein the calculating minimized maximum band loads and minimized number of inter-frequency comprises a linear program (LP).

9. A method performed by an electronic device of a wireless communication system, the method comprising:
receiving channel qualities and movements reports from a plurality of user equipments (UEs);
based on the channel qualities and the movements reports, determining whether a load balancing index (LBI) is lower than a predetermined threshold, wherein the LBI indicates a level of a distribution of a plurality of loads of the plurality of UEs in a plurality of operating bands for the plurality of UEs;
based on identifying that the LBI is lower than the predetermined threshold, determining an assignment matrix between the plurality of UEs and the plurality of operating bands by calculating minimized maximum band loads and minimized number of inter-frequency handovers (HOs), wherein each entry of the assignment matrix comprises a probability of assigning one UE of the plurality of UEs to one operating band of the operating bands; and
transmitting a message to a first UE of the plurality of UEs, wherein the message indicates that the first UE is assigned to a first operating band of the plurality of the operating bands, based on the assignment matrix.

10. The method of claim 9, further comprising assigning an second UE in the plurality of UEs to a second operating band of the plurality of operating bands,
wherein the second UE is excluded from performing the inter-frequency HOs, and
wherein the second operating band has the highest value of channel quality among the plurality of operating bands.

11. The method of claim 10, wherein the channel qualities corresponds to reference signal received quality (RSRQ).

12. The method of claim 10, the second UE is excluded from the calculating minimized maximum band loads and minimized number of inter-frequency HOs.

13. The method of claim 10, a data rate of the second UE is lower that a predetermined minimum data rate of the wireless communication system.

14. The method of claim 9, wherein the message corresponds to a radio resource control (RRC) configuration message.

15. The method of claim 9, wherein the calculating minimized maximum band loads and minimized number of inter-frequency comprises at least one non-negative slack variable.

16. The method of claim 9, wherein the calculating minimized maximum band loads and minimized number of inter-frequency comprises a linear program (LP).

17. An electronic device of a wireless communication system, the electronic device comprising:
at least one processor; and
at least one memory comprising computer program code, wherein the at least one memory and the computer program code are configured, with the at least one processor, to cause the electronic device to at least:
set statistical means of band-assignment probabilities for each band below probability threshold, based on related resources;
obtains assignments between a plurality of user equipments (UEs) and a plurality of operating bands, rate measurements of the plurality of UEs, and traffic data statistics of the plurality of UEs;
estimate a potential added load from at least one UE of the plurality of UEs to at least one frequency band of the plurality of operating bands;
determine an assignment matrix between the plurality of UEs and the plurality of operating bands by calculating minimized maximum band loads and minimized number of inter-frequency handovers (HOs), wherein each entry of the assignment matrix comprises a probability of assigning one UE of the plurality of UEs to one operating band of the operating bands;
based on the assignment matrix, obtain a band assignment probability distribution for the at least one UE; and
transmit a message to the at least one UE for an inter-frequency HO by the at least one UE.

18. The electronic device of claim 17, wherein the message corresponds to a radio resource control (RRC) configuration message.

19. The electronic device of claim 17, wherein the calculating minimized maximum band loads and minimized number of inter-frequency comprises at least one non-negative slack variable.

20. The electronic device of claim 17. wherein the calculating minimized maximum band loads and minimized number of inter-frequency comprises a linear program (LP).
